(19) United States
(12) Patent Application Publication
(10) Pub. No.: US 2023/0359785 A1
(43) Pub. Date: Nov. 9, 2023

(54) COMPUTER-IMPLEMENTED METHOD FOR SIMULATING AN ELECTRIC DRIVE

(71) Applicant: dSPACE GmbH, Paderborn (DE)

(72) Inventor: Nils HOLTHAUS, Schlangen (DE)

(73) Assignee: dSPACE GmbH, Paderborn (DE)

(21) Appl. No.: 18/143,672

(22) Filed: May 5, 2023

(30) Foreign Application Priority Data
May 6, 2022 (DE) 10 2022 111 267.5

(51) Int. Cl. G06F 30/20

(52) U.S. Cl. CPC G06F 30/20

(57) ABSTRACT

A computer-implemented method for simulating an electric drive by means of at least one processing unit of a hardware-in-the-loop simulator, A model of the electric drive ha an inverter powered by a DC voltage source with at least one half-bridge having at least two semiconductor switches and an electric motor having an electrical winding resistance and a winding inductance. A center tap having a center tap voltage of the half-bridge is connected by means of a supply line having a supply line current to a motor connection of the electric motor. By actuating the semiconductor switches, the motor connection can be connected either to an electrical potential of the DC voltage source with an open semiconductor switch in a conductive state of the inverter or the motor connection can be unlocked in terms of potential in an open state of the inverter with at least two semiconductor switches open.

This nonprovisional application claims priority under 35 U.S.C. § 119(a) to German Patent Application No. 10 2022 111 267.5, which was filed in Germany on May 5, 2022, and which is herein incorporated by reference.

### BACKGROUND OF THE INVENTION

### Field of the Invention

The invention relates to a computer-implemented method for simulating an electric drive by means of at least one processing unit of a hardware-in-the-loop simulator, wherein the model of the electric drive comprises an inverter powered by a DC voltage source with at least one half-bridge having at least two semiconductor switches and an electric motor having an electrical winding resistance and a winding inductance, wherein a center tap having a center tap voltage of the half-bridge is connected to a motor connection of the electric motor by means of a supply line with a supply line current and wherein by actuating the semiconductor switches, the motor connection can be connected to an electrical potential of the DC voltage source either with an open semiconductor switch in a conductive state of the inverter or the motor connection can be unlocked in terms of potential in an open state of the inverter with at least two open semiconductor switches.

### Description of the Background Art

The computer-implemented method described above is based in the technical field of real-time simulation of electrical circuits, in this case in the form of an electric drive, for the purpose of influencing or testing a technical-physical process. The technical-physical process can be, for example, control units, such as those used in large numbers in motor vehicles, aircraft, power generation or distribution systems, etc. An essential application of the computer-implemented method is the so-called hardware-in-the-loop simulation (HIL simulation). If the computer-implemented method described above is carried out as part of an HIL simulation, the simulation is carried out by calculating the model of the electric drive, i.e., the model in the form of numerically calculable equations on a computer, on the processing unit—or, if necessary, on several processing units—of the HIL simulator.

The simulator usually has an I/O interface via which electrical signals can be read in or output. Via this I/O interface, the simulator is connected to the real technical-physical process, in the described application usually to an electronic ECU to be tested, which is often referred to as device-under-test (DUT) in this context. The HIL simulator simulates the technical environment of the connected electronic control unit in which the control unit to be tested is actually to be used later, in this case an electric drive with a DC voltage fed inverter and an electric motor connected to the inverter.

The control unit to be tested outputs electrical control signals via its own I/O interface in order to control the inverter. The control signals are essentially signals for controlling the semiconductor switches of the half-bridge of the inverter of the electric drive. Conversely, the HIL simulator can, for example, output state variables of the electric drive to the ECU via its I/O interface, which the ECU later evaluates and checks in its real operating environment. In the present case, the simulated electric drive includes not only the motor itself, but also the power-electronic control in the form of the inverter and the DC voltage source supplying the inverter (fed DC link). In this form, the computer-implemented method is therefore suitable for testing an ECU to be tested at the signal level.

The electric drive described above, or the model of the electric drive, is initially single-phase in the form described with at least one half-bridge, but the method is not limited to single-phase motors. Often, these will be multiphase drives and motors, i.e., with a correspondingly higher number of half-bridges, each having at least two semiconductor switches. In this respect, in these cases there are also a plurality of center taps, a plurality of supply lines and connected motor phases, which in turn each have a winding resistance and a winding inductance. The method for simulating an electric drive can also be easily applied to such multiphase drives.

Semiconductor switches are often field-effect transistors that are designed to switch correspondingly high currents. These semiconductor switches are usually connected in parallel with freewheeling diodes, which become conductive at high counter voltages and are also understood here as being part of the semiconductor switches. The freewheeling diodes are not actively switchable into a conductive or blocking state, instead they automatically assume their switching state depending on their electrical port sizes; this must be taken into account in the simulation.

The simulation of electric drives places high demands on the simulation hardware used, i.e., on the computing/processing units used and their memory configuration, especially because the simulation usually has to be carried out in real time, since it has to interact with a real process, i.e., essentially the ECU under test. The variables/parameters obtained from the ECU must therefore be processed in real time as part of the simulation. It is therefore important to ensure that requirements in terms of computing time and memory are met.

The simulation of the electric drive is often carried out not only on one processing unit, but on several processing units of the simulator. The processing units can be different cores of a processor, but they can also be different processors of a multiprocessor system, which is often the case with larger HIL simulators. It is also possible that a processing unit or several processing units are implemented on the basis of one or more FPGA (Field Programmable Gate Array), which offers speed advantages, but also difficulties with regard to certain numerical operations, such as divisions.

The simulation of the electric drives mentioned above has proven to be very challenging, since the different operating states of the inverter, i.e., conductive state with a closed semiconductor switch and open state with two open semiconductor switches (floating center tap), are accompanied by very different dynamics of the currents involved. Whereas in the conductive state of the inverter in the simulation, comparatively slow current dynamics of the supply line current have to be managed, in the open state of the inverter there are considerably faster current dynamics of the supply line current, which can lead in particular to considerable stability problems in the numerical simulation.

### SUMMARY OF THE INVENTION

It is therefore an object of the present invention to provide a method for simulating an electric drive, by means of which a stable simulation of the electric drive, in particular when the inverter is in the open state, is possible, preferably without deviating significantly from the actual dynamic behavior of the electric drive.

In the computer-implemented method, the object is initially and essentially achieved by separating the model of the electric drive into an inverter subcircuit and a motor subcircuit, which are only numerically coupled to each other via electrical coupling variables, namely the center tap voltage and the supply line current. By separating the model of the electric drive into the inverter subcircuit and the motor subcircuit, it is basically possible to simulate the electric drive on different processing units. At the same time, the hardware requirements in terms of computing power and memory are significantly reduced when calculating each individual sub model. If the following refers to the inverter subcircuit and the motor subcircuit, then parts of the electric drive model are always meant.

It is further provided that the semiconductor switches of the inverter subcircuit will be represented by ohmic resistors, the resistance values of which depend on the switching state of the semiconductor switches. Where the control signals for the semiconductor switches come from, how they are generated, etc., is not of interest here and is not the object of consideration. The only important thing is that the semiconductor switches are controlled and that the half-bridge or inverter can be operated in a conductive and open state. To adjust the center tap voltage, the center tap of the half-bridge is loaded with a load branch with at least one load branch resistor. The supply line current is mapped with a supply power source at the center tap of the half-bridge.

In the case of the motor subcircuit, it is provided that it comprises a series connection formed of a supply line resistor for mapping the supply line, the winding inductance and the winding resistance of the motor (or a phase of the motor), as well as an EMF voltage source on the output side to take into account the electromotive counter voltage induced in the motor and an inverter voltage source on the input side for adjusting the center tap voltage.

By means of the measures described, the model of the electric drive is broken down into two sub models, which can be simulated separately on their own. The coupling variables center tap voltage and supply line current must be exchanged between the models. In the conductive state of the inverter, i.e., in the event that a semiconductor switch of the half-bridge is closed, the physical sequence of action provides that the inverter specifies the center tap voltage and applies it to the motor, and the electrical parameters of the motor then determine which supply line current is present in the motor phase and thus in the corresponding supply line. These electrical interface variables must be exchanged between the sub models, i.e., the motor sub model must be informed of the center tap voltage resulting from the inverter, and the inverter subcircuit must be informed of the supply line current occurring in the motor sub model, since this supply line current must of course also flow via the center tap of the inverter subcircuit.

Overall, it is possible to simulate the inverter subcircuit and the motor subcircuit separately, each using an implicit numerical integration method (e.g., forward-Euler). For this purpose, the system equations, which are usually initially available in continuous-time form, are discretized in time by corresponding known numerical approaches.

In the case of the required numerical discretization using the implicit numerical integration method, an algebraic loop between the sub models is created in such a way that the electrical interface variables must already be present in both sub models as input variables at a new calculation time, hereinafter always referred to as calculation step k, which cannot be solved mathematically in this way.

For this reason, it is provided that this algebraic loop between the inverter subcircuit and the motor subcircuit is resolved by inserting a dead time to the extent of at least one calculation step size of the numerical integration method. For example, instead of using the center tap voltage of the current calculation time k, the center tap voltage of the past calculation time (k−1) is calculated in the motor subcircuit.

As will be explained in more detail in the figure description, the dynamic behavior of the systems, especially with regard to the supply line current, is very different when the inverter is in the open state vs. in the conductive state. The relevant eigenvalue of the uniform description of the current in the conductive state is considerably smaller—and thus the system dynamics “slower”—than in the open state, in which the relevant eigenvalue of the uniform description of the current dynamics is considerably larger. If the time constant of the dynamics in the form of this eigenvalue enters the range of the sampling step size of the numerical integration method, then there is a risk that the calculation as a whole becomes unstable. In turn, the additional dead time contributes to the possible instability of the calculation.

The simulation can be stabilized by parameter switching of the values for the load branch resistance of the load branch in the inverter subcircuit and for the supply line resistance in the motor subcircuit at the runtime of the simulation when switching between the conductive and the open state of the inverter. Because only one parameter switching is performed, the mathematical description of the sub models is structurally invariant, i.e., unchangeable in the structure (existing terms, linking of the terms and arithmetic operations in the terms) when switching between the open and the conductive state of the inverter. As a result, structurally identical, immutable equations can be used to continue calculations even when switching states, even if numerical values are changed for individual parameters during switching, so that no state-dependent sub models have to be kept and stored. The method therefore makes it possible to simulate electric drives on hardware environments with which previously used models could not be calculated. In order to control numerical instabilities, for example, the calculation step size has been reduced in the prior art, which increases the demands on the hardware, or the model of the drive has been modified in such a way in terms of a dynamic slowdown that the simulated dynamics have hardly reflected the real behavior.

The calculation step size of the integration method can be chosen in such a way that the calculation step size is smaller than the reciprocal of the eigenvalue for the supply line current, i.e., the eigenvalue of the description of the supply line current by a differential equation, in the conductive state of the inverter. As previously explained, the mathematical description of the supply line current in the conductive state of the inverter is less critical in time than in the open state of the inverter. In this respect, the choice of the calculation step size as described above is a maximum choice of the calculation step size if it is possible to stabilize the stability of the calculation when the inverter is in the open state, which is ensured by the parameter switching according to the invention at the appropriate position. The choice of the calculation step size causes the dead time in the forward branch in the order of one scan step or one calculation step size to have a negligible influence on the current dynamics of the overall system, at least in the conductive state of the inverter.

In order to achieve stability, it is provided that, in the open state of the inverter, the values for the load branch resistance in the inverter subcircuit and for the supply line resistance in the motor subcircuit can be selected in such a way, that a shift in the eigenvalue of the uniform description of the supply line current is caused in the inverter subcircuit and in the motor subcircuit in such a way, that the inserted dead time in the forward branch between the inverter subcircuit and the motor subcircuit is negligible. In a particularly preferred embodiment, it is envisaged that the inserted dead time in the forward branch between the inverter subcircuit and the motor subcircuit is at least 3 times smaller than the reciprocal of the eigenvalue for the supply line current, preferably the inserted dead time in the forward branch between the inverter subcircuit and the motor subcircuit is at least an order of magnitude smaller than the reciprocal of the eigenvalue for the supply line current; this has corresponding consequences for the choice of the calculation step size if the dead time corresponds to a calculation step size of the numerical discretization.

The required eigenvalue shift can be caused by the fact that the resistance value for the supply line resistance in the motor sub model—when the inverter is in the open state—is set to a high lock-out value, so that the supply line current in the motor model behaves practically independently of the inverter voltage source in the motor model. In particular, the lock-out value is not chosen to be less than an order of magnitude smaller than the lock-out value for an open semiconductor circuit of the semiconductor bridge.

In the open state of the inverter, the value for the load branch resistance in the inverter subcircuit can be set to a value that is at least two orders of magnitude smaller than the value for the load branch resistance in the conductive state of the inverter. Preferably, the load branch resistance value is set to a value that is at least four orders of magnitude smaller than the load branch resistance value in the conductive state of the inverter. As a result, when changing from the conductive state of the inverter to the open state of the inverter, the resistance values of the load branch resistor and the supply line resistance are switched. While the load branch resistance changes from a high value (for example, 1 MOhm) to a low value (for example, 1 ohm), the supply line resistance changes from a low resistance value (for example, 1 ohm) to a very high, decoupling resistance value (for example, 1 MOhm).

As has already been explained, in the conductive state of the inverter, the inverter specifies a center tap voltage, which can be applied to the motor. The applied voltage then causes a supply line current. For the open state of the inverter, the direction of action is different. The inverter is unlocked in terms of potential, i.e. “floating”, so that the potential at the center tap is no longer specified by the inverter and the half-bridge of the inverter. In fact, the center tap voltage is determined by the state of motion of the motor. In order not to change the way in which the inverter sub model and the motor sub model are calculated even in the open operating state of the inverter, the supply power source of the inverter sub model is set in such a way that there is a corresponding center tap voltage in the inverter sub model. In a preferred embodiment of the method, it is therefore provided that in the open state of the inverter, for setting the motor input voltage as the center tap voltage of the inverter sub model, the amperage of the supply power source of the inverter sub model is set to the quotient of the motor input voltage of the motor sub model and the value of the load branch resistance. This procedure is based on the idea that, due to the blocked current flow in the supply line, there is practically no voltage drop across the supply line resistor, so that the motor input voltage corresponds to the voltage that is also applied to the center tap of the inverter. This boundary condition is satisfied if the supply power source of the inverter sub model is set as described above.

The object is further achieved by a simulator with a processing unit for simulating an electric drive, wherein the processing unit is programmed with a program in such a way that it executes the described method when executing the program.

In addition, the object is achieved with a computer program, comprising commands which cause, when the program is executed by a processing unit of a simulator, said processing unit to execute the described method.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows, schematically, an application of the computer-implemented method in which an electric drive is simulated by means of a hardware-in-the-loop simulator for testing a connected electronic control unit,

FIG. 2 shows, schematically, the drive to be simulated as an electrical circuit diagram,

FIG. 3 shows, schematically, the approach for simulating the electric drive according to FIG. 2 by means of electrical equivalent variables, and

FIG. 4 shows the separation of the model of the electric drive into an inverter subcircuit and a motor subcircuit with electrical coupling variables.

### DETAILED DESCRIPTION

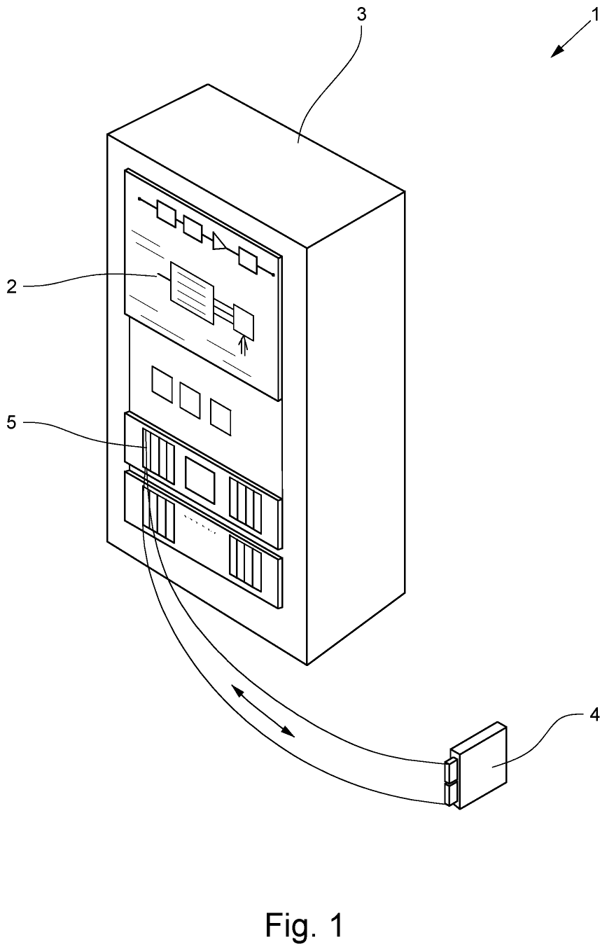

FIGS. 1 to 4 show various aspects of a computer-implemented method 1 for simulating an electric drive by means of a processing unit of a hardware-in-the-loop simulator 3, wherein this simulator 3 is shown only in FIG. 1.

FIG. 1 shows the typical application of the computer-implemented method 1 explained here. The HIL simulator 3 comprises a processing unit that is not explicitly displayed, on which it calculates a model 2—meaning a numerically calculable, mathematical model—of an electric drive and in this respect simulates the electric drive. The simulator 3 has an I/O interface 5 through which the simulator 3 is connected to an electronic ECU 4, namely via a corresponding I/O interface of the ECU 4. The control unit 4 transmits control signals to the simulator 3 and thus influences certain switching states of the model 2 of the electric drive. Conversely, the simulator 3 outputs state variables of the calculated model 2 of the electric drive to the ECU 4 via the I/O interface 5. As a result, the ECU 4 can be tested in a simulated environment of the ECU 4 provided by the method 1.

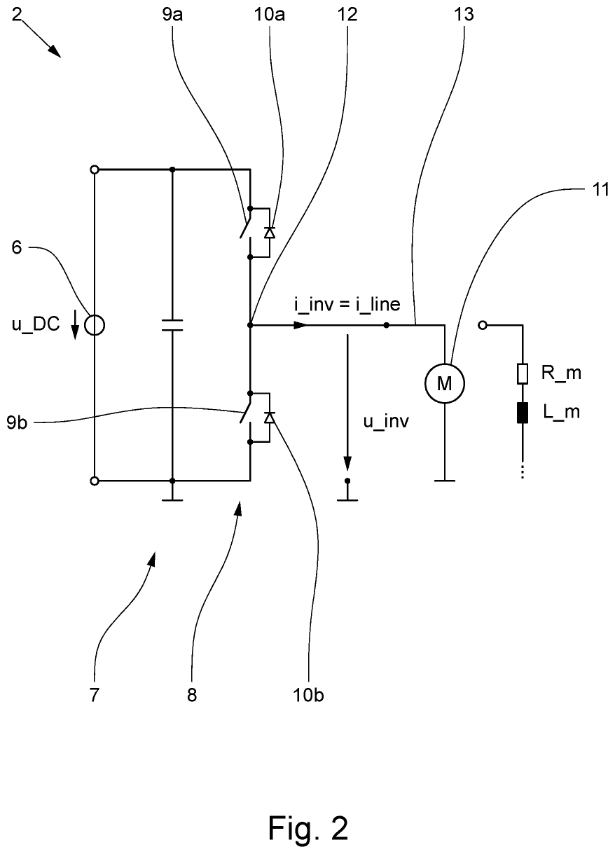

FIG. 2 shows the model 2 of the electric drive to be simulated here in the form of an electrical circuit diagram. The model 2 of the electric drive comprises an inverter 7 powered by a DC voltage source 6 with a half-bridge 8 having two semiconductor switches 9a, 9b. At a center tap 12 between the two semiconductor switches 9a, 9b, a center tap voltage u_inv of the half-bridge 8 is connected to a motor connection of an electric motor 11 by means of a supply line 13. In normal operation, a supply line current i_inv flows via the supply line 13. The semiconductor switches 9a, 9b are circuit breakers in MOSFET technology. Parallel to the semiconductor switches, freewheeling diodes 10a, 10b are connected, which release currents in operating states directed opposite to the usual motor operating current direction. These freewheeling diodes 10a, 10b are added here to the semiconductor switches 9a, 9b for further consideration.

FIG. 2 shows the drive elements required for a single-phase electric motor 11, which has only one single-phase conductor, which can be described electrically by a series connection of an electrical winding resistance R_m and a winding inductance L_m. The computer-implemented method 1 is not limited to single-phase models 2 of electric drives and such electric motors; of course, multiphase electric drives can be addressed just as well, which then have a corresponding number of half-bridges 8 with a corresponding number of center taps 12 according to the number of motor phases.

By actuating the semiconductor switches 9a, 9b, the motor connection can either be connected to an electrical potential of the DC voltage source 6 with an open semiconductor switch 9a, 9b— and thus with a closed semiconductor switch 9b, 9a— in a conductive state of the inverter 7, or the motor connection can be unlocked in terms of potential, i.e. “floating”—all semiconductor switches 9a, 9b of the half-bridge 8 are open in an open state of the inverter 7 with at least two semiconductor switches 9a, 9b.

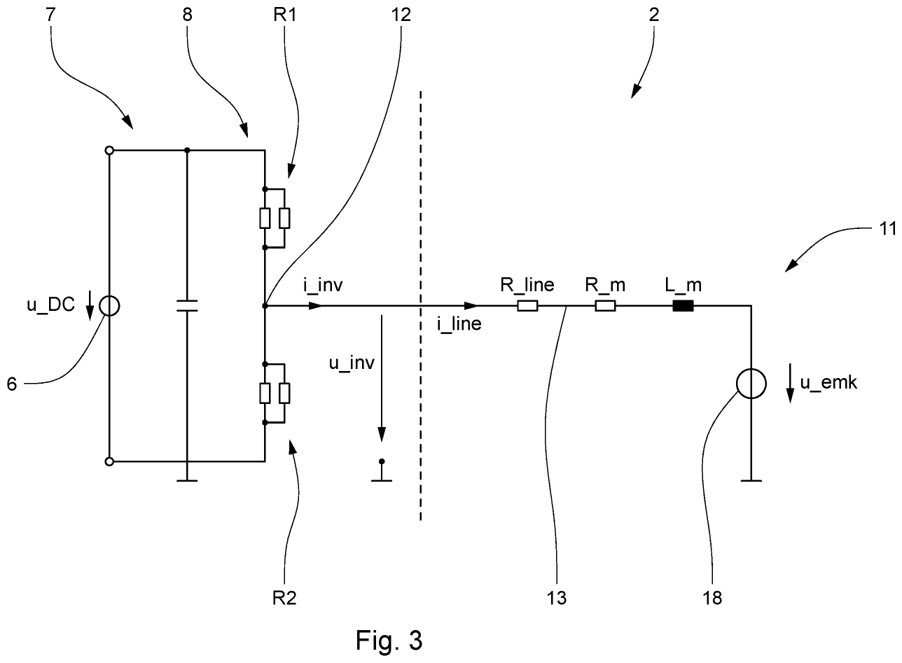

FIG. 3 shows a further step for the derivation of the model 2 of the electric drive. The semiconductor switches 9a, 9b including the diodes 10a, 10b are represented here by ohmic resistors R1, R2, wherein the different switching states of the semiconductor switches 9a, 9b (and possibly the diodes 10a, 10b) can be simulated by corresponding change in the resistance values of the resistors R1, R2. The model 2 thus remains structurally the same, regardless of the switching state of the semiconductor switches 9a, 9b; only the resistance values assigned to the resistors R1, R2 depend on the switching state of the semiconductor switches 9a, 9b.

The electric motor 11 has also been supplemented by an EMF voltage source 18 by which, depending on the operating state of the electric motor 11, the counter voltage induced in the phase conductor of the electric motor 11 can be simulated. The initial idea is to separate this model 2 of the electric drive into two sub models, for which reason a dashed line has been drawn at the corresponding point in FIG. 3. As a result, the complexity of the calculation of the model 2 is reduced; in particular, it is possible to calculate the sub models 14, 15 on different processing units.

On the basis of FIG. 3, the dynamics of the supply line current i_inv are to be shown by setting up the mesh equation via the DC voltage source 6, the half-bridge 8, the supply line 13 and the electric motor with its electrical equivalent quantities (Equation 1):

$$\frac{di\_inv ( t )}{dt} = - \frac{1}{L\_m} u\_emk ( t ) + \frac{1}{L\_m} \frac{R 2}{R 1 + R 2} u\_DC ( t ) - \frac{1}{L\_m} ( 2 ( R\_line + R\_m ) + \frac{2 R 1 R 2}{R 1 + R 2} ) i\_inv ( t )$$

From the equation, the eigenvalue lambda of the differential equation for the supply line current i_inv can be read (Equation 2):

$$λ = - \frac{R}{L\_m} , mit \qquad R = 2 ( R\_line + R\_m ) + \frac{2 R 1 R 2}{R 1 + R 2}$$

Since the supply line resistance R_line and the winding resistance R_m are small line resistances, the total resistance R can only become very large if both R1 and R2 assume large values, which is only the case if both semiconductor switches 9a, 9b of the half-bridge 8 are open, i.e., the inverter 7 is in the open state. If the inverter 7 is in the conductive state, then the eigenvalue lambda for the supply line current i_inv is small. The problem that arises here is that the current dynamics in both cases considered, conductive inverter 7, open inverter 7, are very different and consequently the numerical calculation of the equational relationships in the context of the calculation of the model 2 of the electric drive is also different in terms of dynamics and has different stability requirements. While changes in the supply line current i_inv are relatively slow when the inverter 7 is in the conductive state, the calculation of the supply line current i_inv when the inverter 7 is in the open state is considerably more dynamic and demanding and can lead to unstable behavior in a calculation step size that leads to a stable calculation when in the conductive state.

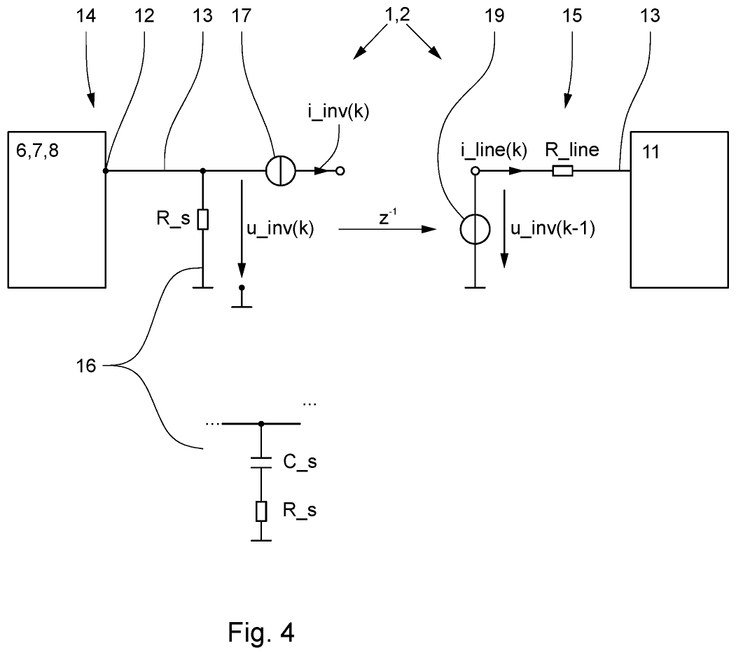

Having this in mind, the method 1 according to the invention for simulating an electrical operation is shown in FIG. 4. In the design of the method 1, it is provided that the model 2 of the electric drive is separated into an inverter subcircuit 14 and a motor subcircuit 15, as has already been indicated in FIG. 3. The inverter subcircuit 14 and the motor subcircuit 15 are only numerically coupled to each other via electrical coupling variables, namely the center tap voltage u_inv (k) and u_inv (k−1) and the supply line current i_inv, i_line. For the supply line current, two different identifiers, i_inv and i_line, have been used here to distinguish whether reference is made to the supply line current in the inverter subcircuit 14 or in the motor subcircuit 15. The calculation step k or k−1 in parentheses indicates from which calculation step the electrical quantities in the sub models 14, 15 interact.

As has already been explained in FIGS. 2 and 3, the method 1 also provides that the semiconductor switches 9a, 9b of the inverted subcircuit 14 are represented by ohmic resistors R1, R2, the resistance values of which depend on the switching state of the semiconductor switches 9a, 9b. For example, in the switched state of the semiconductor switches 9a, 9b, these have a resistance value Ron, which corresponds to the resistance value of a switched MOSFET transistor. Values for the resistance can be a few ohms, or fractions of an ohm; for some calculations a resistance of 0 ohms may also be assumed. In the open state of the semiconductor switches 9a, 9b, resistance values Roff are established, which describe the line resistance of the unactuated, locked semiconductor switches 9a, 9b; For example, Roff can have a resistance value of 1 MOhm. The center tap 12 of the half-bridge 8 is loaded with a load branch 16 with a load branch resistance R_s for adjusting the center tap voltage u_inv (k). The supply line current i_inv (k) is mapped to the motor subcircuit 15 with the supply power source 17 at the center tap 12 of the bridge 8.

The motor subcircuit 15 comprises a series connection from the supply line resistance R_line to map the supply line 13, the winding inductance L_m and the winding resistance R_m of the motor 11. Furthermore, the motor subcircuit 15 comprises the EMF voltage source 18 on the output side, which is not shown separately here, but is encompassed by the block representing the motor 11. Furthermore, the motor subcircuit 15 has the inverter voltage source 19 on the input side for adjusting the center tap voltage u_inv (k−1).

It is now provided that the inverter subcircuit 14 and the motor subcircuit 15 or the equivalent descriptions of the inverter subcircuit 14 and the motor subcircuit 15 will be simulated separately, each using an implicit numerical integration method with which the mathematical description is discretized in time. When this approach is taken, an algebraic loop is created between the coupling variables of the inverter subcircuit 14 and the motor subcircuit 15. It turns out that in order to calculate the values of the interface variables in the current calculation step, the current values must already be available, which constitutes an algebraic loop and cannot be resolved without further measures.

As a solution, the method 1 provides that the algebraic loop between the inverter subcircuit 14 and the motor subcircuit 15 is resolved by inserting a dead time (z\hat{ }−1) to the extent of at least one calculation step size of the numerical integration method. Therefore, in the motor subcircuit 15, the center tap voltage u_inv (k−1) is only required from the past calculation step, while in the inverter subcircuit 14 the center tap voltage must be known in the current calculation step u_inv (k). Already in the motor subcircuit 15, the supply line current i_line (k) can be calculated using the center tap voltage u_inv(k−1) from the last calculation step, which means that the supply line current i_inv (k) in the inverter subcircuit 14 is also known. By inserting the dead time, there is an additional stability problem. In the conductive state of the inverter, the insertion of the dead time in the range of a calculation step size is not critical, since the system dynamics, as shown above, are comparatively slow. In the case of the simulation of the electric drive for the open state of inverter 7, there are considerably larger eigenvalues for the current dynamics, which is why the insertion of the dead time between the inverter subcircuit 14 and the motor subcircuit 15 further increases the risk of numerical instability. In order to counteract this, the method according to FIG. 4 provides that the simulation is stabilized in the event of a change between the conductive and the open state of the inverter 7 by parameter switching of the values for the load branch resistance R_s of the load branch 16 in the inverter subcircuit 14 and for the supply line resistance R_line in the motor subcircuit 15 at runtime of the simulation.

In order for the simulation to be stable in principle, the method 1 as shown in FIG. 4 provides that the calculation step of the integration method is chosen in such a way that it is less than the reciprocal of the eigenvalue for the supply line current i_inv in the conductive state of the inverter 7. Since the conductive state of the inverter 7 is the dynamically less demanding case for the calculation of the model 2 of the electric drive, a stable simulation for the normal operating case is ensured.

In the case of stabilization by parameter switching, it is provided that in the conductive state of the inverter 7 the values for the load branch resistance R_s in the inverter subcircuit 14 and for the supply line resistance R_line in the motor subcircuit 15 are selected in such a way that the value of the load branch resistance R_s exceeds the value of the supply line resistance R_line by at least three orders of magnitude. This measure ensures that the load branch 16 does not load the center tap 12 on the side of the inverter subcircuit 14.

The parameter switching, which is carried out in the method 1 according to FIG. 4 is characterized by the fact that, in the open state of the inverter 7, the values for the load branch resistance R_s in the inverter subcircuit 14 and for the supply line resistance R_line in the motor subcircuit 15 are selected in such a way that in the inverter subcircuit 14 and in the motor subcircuit 15, a shift in the eigenvalue of the uniform description of the supply line current i_line is effected, such that the inserted dead time z\hat{ }−1 in the forward branch between the inverter subcircuit 14 and the motor subcircuit 15 is negligible.

Specifically, it is provided that in the motor sub model 15, the resistance value for the supply line resistance R_line for the open state of the inverter 7 is set to a high lock-out value, so that the supply line current i_line(k) in the motor sub model 15 behaves practically independently of the inverter voltage source 19 in the motor sub model 15. Here, the resistance value for the supply line resistance R_line has been set to a value similar to that for the open state of the inverter 7, which corresponds to the resistance value of the open semiconductor switch 9a, 9b.

In a variant of the method 1 indicated in FIG. 4, the model 2 of the electric drive is characterized by the fact that the load branch 16 additionally includes a load branch capacitor C_s connected in series to the load branch resistor R_S. For parameter switching, the value for the capacitance of the load branch capacitor C_s in the conductive state of the inverter 7 is small in relation to the value for the capacitance of the load branch capacitor C_s in the open state of the inverter 7. In the present case, the values for the capacitance of the load branch capacitor C_s in the conductive and open state of the inverter 7 differ by twelve orders of magnitude, wherein the value for the capacitance of the load branch capacitor C_s is one μF in the conductive state of the inverter 7.

In the conductive state of the inverter 7, the center tap voltage u_inv(k) is specified by the inverter subcircuit 14, the center tap voltage u_inv(k) determines the current in the motor 11 and thus in the supply line 13. When the inverter 7 is in the open state, this sequence of action no longer applies since the center tap 12 is unlocked in terms of potential and therefore “floating”. The center tap voltage is determined by the state of motion of the motor and by the resulting induced phase voltage u_m, which is applied to the input of the motor and thus also to the center tap 12. In order to be able to maintain the calculation sequence for the conductive state of the inverter 7 even in the open state of the inverter 7, the knowledge of the center tap voltage u_inv(k) at the level of the motor input voltage u_m on the motor 11 of the motor sub model 15 is used. The method 1 then provides that in the open state of the inverter 7, for setting the motor input voltage u_m as center tap voltage u_inv(k) of the inverter sub model 14, the amperage i_inv (k) of the supply power source 17 of the inverter sub model 14 is set to the quotient of the motor input voltage u_m of the motor sub model 15 and the value of the load branch resistance R_s for the open state of the inverter 7. For this purpose, the motor input voltage u_m is calculated from the difference between the voltage u_inv(k−1) of the inverter voltage source 19 and the voltage across the supply line resistance R_line of the motor sub model 15. Accordingly, the following applies (Equation 3):

$$i\_inv ( k ) = - \frac{u\_m}{R\_s} = - \frac{u\_inv ( k - 1 ) - R\_line \cdot i\_line ( k )}{R\_s}$$

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer implemented method to simulate an electric drive via at least one processing unit of a hardware-in-the-loop simulator, wherein a model of the electric drive comprises an inverter powered by a DC voltage source with at least one half-bridge having at least two semiconductor switches and an electric motor having an electrical winding resistance and a winding inductance, the method comprising:
connecting a center tap having a center tap voltage of the half-bridge via a supply line having a supply line current to a motor connection of the electric motor; and wherein
actuating the semiconductor switches such that the motor connection is either connectable to an electrical potential of the DC voltage source in a conductive state of the inverter with an open semiconductor switch or the motor connection is activatable in an open state of the inverter with at least two semiconductor switches open;
separating the model of the electric drive into an inverter subcircuit and a motor subcircuit, which are numerically coupled to each other only via electrical coupling variables, the center tap voltage or the supply line current, the semiconductor switches of the inverter subcircuit being represented by ohmic resistors whose resistance values depend on the switching state of the semiconductor switches;
loading the center tap of the half-bridge with a load branch having at least one load branch resistance to adjust the center tap voltage; and
mapping the supply line current with a supply power source at the center tap of the half-bridge to the motor subcircuit,
wherein the motor subcircuit comprises a series connection formed a supply line resistor for mapping the supply line, the winding inductance and the winding resistance of the motor, as well as an EMF voltage source on an output side to take into account the electromotive counter voltage induced in the motor and an inverter voltage source to adjust the center tap voltage on an input side,
wherein the inverter subcircuit and the motor subcircuit are simulated separately, each using an implicit numerical integration method,
wherein an algebraic loop between the inverter subcircuit and the motor subcircuit is resolved by inserting a dead time to the extent of at least one calculation step size of the numerical integration method, and
wherein the simulation is stabilized when switching between the conductive and the open state of the inverter by parameter switching of the values for the load branch resistance of the load branch in the inverter subcircuit and for the supply line resistance in the motor subcircuit at runtime of the simulation.

2. The method according to claim 1, wherein the calculation step size of the integration method is chosen such that it is less than the reciprocal of the eigenvalue for the supply line current in the conductive state of the inverter or one order of magnitude less than the reciprocal of the eigenvalue for the supply line current in the conductive state of the inverter.

3. The method according to claim 1, wherein, in the conductive state of the inverter, the values for the load branch resistor in the inverter subcircuit and for the supply line resistance in the motor subcircuit are selected such that the value of the load branch resistance exceeds the value of the supply line resistance by at least three orders of magnitude, and wherein the supply line resistance describes the actual resistance of the supply line.

4. The method according to claim 1, wherein, in the open state of the inverter, the values for the load branch resistance in the inverter subcircuit and for the supply line resistance in the motor subcircuit are selected such that in the inverter subcircuit and in the motor subcircuit, a shift of the eigenvalues of the uniform description of the supply line current is effected so that the inserted dead time in the forward branch between the inverter subcircuit and the motor subcircuit is negligible, or such that the inserted dead time in the forward branch between the inverter subcircuit and the motor subcircuit is at least three times smaller than the reciprocal of the eigenvalue for the supply line current, or such that the inserted dead time in the forward branch between the inverter subcircuit nd the motor subcircuit is at least one order of magnitude smaller than the reciprocal of the eigenvalue for the supply line current.

5. The method according to claim 4, wherein in the motor sub model the resistance value for the supply line resistance is set to a high lock-out value so that the supply line current in the motor sub model behaves practically independently of the inverter voltage source in the motor sub model, or wherein the lock-out value is not less than an order of magnitude of the lock-out value for an open semiconductor switch.

6. The method according to claim 5, wherein in the open state of the inverter the value for the load branch resistance in the inverter subcircuit is set to a value which is at least two orders of magnitude smaller than the value for the load branch resistance in the conductive state of the inverter or is set to a value which is at least four orders of magnitude smaller than the value for the load branch resistance in the conductive state of the inverter.

7. The method according to claim 1, wherein the load branch additionally comprises a load branch capacitor connected in series to the load branch resistor.

8. The method according to claim 7, wherein the value for the capacitance of the load branch capacitor in the conductive state of the inverter is small in relation to the value for the capacitance of the load branch capacitor in the open state of the inverter or the values for the capacitance of the load branch capacitor in the conductive and open state of the load branch capacitor differ by at least six orders of magnitude or by twelve orders of magnitude, or wherein the value for the capacitance of the load branch capacitor in the conductive state of the inverter is in the range of 1 μF.

9. The method according to claim 1, wherein in the open state of the inverter, for adjusting the motor input voltage as the center tap voltage of the inverter sub model, the amperage of the supply power source of the inverter sub model is set to the quotient of the motor input voltage of the motor sub model and the value of the load branch resistance.

10. The method according to claim 9, wherein the motor input voltage is calculated from the difference between the voltage of the inverter voltage source and the voltage across the supply line resistance of the motor sub model.

11. A simulator comprising a processing unit for simulating an electric drive, wherein the processing unit is programmed with a program to execute the method according to one claim 1 when executing the program.

12. A computer program comprising commands which, when executing the program by a processing unit of a simulator, cause the program to execute the method according to claim 1.
